(19) United States
(12) Patent Application Publication
(10) Pub. No.: US 2026/0275466 A1
(43) Pub. Date: Sep. 17, 2026

(54) HIGH-STRENGTH AND LOW-IRON-LOSS NON-ORIENTED ELECTRICAL STEEL PLATE AND MANUFACTURING METHOD THEREFOR

(71) Applicant: Baoshan Iron & Steel Co., Ltd., Shanghai (CN)

(72) Inventors: Feng Zhang, Shanghai (CN); Xuejun Lv, Shanghai (CN); Bo Wang, Shanghai (CN); Guobao Li, Shanghai (CN)

(21) Appl. No.: 19/162,627

(22) PCT Filed: Mar. 6, 2024
(86) PCT No.: PCT/CN2024/080349

§ 371 Date: Sep. 5, 2025

(30) Foreign Application Priority Data
Mar. 16, 2023 (CN) 202310258348.X

(51) Int. Cl. C22C 38/02; C21D 1/28; C21D 1/30; C21D 1/74; C21D 6/00; C21D 8/1216; C21D 8/1244; C21D 8/1277; C21D 9/46; C22C 38/00; C22C 38/04; C22C 38/06; C22C 38/16; C22C 38/60; H01F 1/147

(52) U.S. Cl. CPC C22C 38/02; C21D 1/28; C21D 1/30; C21D 1/74; C21D 6/005; C21D 6/008; C21D 8/1222; C21D 8/1233; C21D 8/1261; C21D 8/1266; C21D 8/1283; C21D 9/46; C22C 38/001; C22C 38/002; C22C 38/004; C22C 38/005; C22C 38/008; C22C 38/04; C22C 38/06; C22C 38/16; C22C 38/60; H01F 1/14791; C22C 2202/02

(57) ABSTRACT

Disclosed in the present invention is a non-oriented electrical steel plate. In addition to Fe and inevitable impurities, the non-oriented electrical steel plate further contains the following chemical elements in wt %: 0<C≤0.0035%, Si: 2.00-3.80%, Mn: 0.05-1.00%, Al: 0.10-1.20%, and Cu: 0.05-2.00%. Correspondingly, further disclosed in the present invention is a method for manufacturing the non-oriented electrical steel plate, wherein in a heating step, the heating rate of a casting slab in a temperature range of 940-1030° C. is 4.5-8.4° C./min; and in a leveling step, the leveling reduction rate is controlled to be 0.5-8.0%. By using this technical solution, the present invention achieves both low iron-loss performance and high strength.

### TECHNICAL FIELD

The present invention relates to a steel plate and a manufacturing method therefor, in particular to a non-oriented electrical steel plate and a manufacturing method therefor.

### BACKGROUND

In recent years, to continuously improve the power efficiency of components such as high-speed electric tools and new energy vehicle drive motors, the non-oriented electrical steel plate, which is the key raw material for these components, is expected to have a finished thickness of 0.30 mm or less to significantly reduce iron loss of the steel plate. In addition, with the increasing requirements for lightweight design of iron cores, it is expected that the yield strength of the finished steel plate should be no less than 500 MPa, or even higher.

For example, the invention application with publication number CN107974620A, publication date May 1, 2018, and titled “A non-oriented silicon steel with a yield strength ≥600 MPa for high-speed motors and manufacturing method therefor”, discloses a non-oriented silicon steel for high-speed motors with a yield strength of 600 MPa grade and manufacturing method therefor. The chemical composition of the silicon steel is: C: 0.001%-0.003%, Si: 2.6%-3.4%, Mn: 0.20%-0.60%, P≤0.005%, S≤0.005%, Als: 0.75%-0.95%, N: 0.002%-0.006%, Nb: 0.053%-0.20%, with the balance being Fe and unavoidable impurities. In addition, it must satisfy the following relationships: 4.5%≤Si+2Als−0.5Mn+2.92P≤5.0%, the soluble niobium content is 0.04%≤Nb %≤0.08%, and Nb %=(Nb/93−C/12−N/14)*100, 1≤N/C≤3. The production steps of non-oriented silicon steel are as follows: smelting in a converter and casting into continuous billets; heating the continuous billets, performing conventional rough rolling and finish rolling, and controlling the thickness of the hot-rolled plate to 2.10±0.05 mm; during normalization, controlling the normalizing soaking temperature to be 840-940° C.; cold rolling the normalized steel coil after pickling, and the cold-rolled finished product has a thickness of no more than 0.35 mm; then, continuous annealing the cold-rolled finished product, controlling the soaking temperature to be 780-820° C., the soaking time to be 60-120 seconds, and the atmosphere to be pure dry N₂. The resulting steel plates, with a finished thickness not exceeding 0.35 mm, achieve the following mechanical properties: yield strength ≥600 MPa, tensile strength ≥700 MPa, iron loss P_{10/400}≤35 W/kg, and magnetic induction B₅₀≥1.60 T. It can be seen that the technical solution mainly relies on Nb element, but the iron loss of the non-oriented electrical steel remains insufficiently low.

### SUMMARY

One objective of the present invention is to provide a high-strength, low-iron-loss non-oriented electrical steel plate. By employing a novel chemical composition design and a compatible process, the invention ensures that the steel for white plate (steel after continuous annealing and appropriate leveling) has high strength, and the steel for black plate (steel after stress-relief annealing) has low iron loss.

To achieve the above objective, the present invention provides a non-oriented electrical steel plate. In addition to Fe and inevitable impurities, the steel plate further comprises the following chemical elements in wt %:
0<C≤0.0035%, Si: 2.00-3.80%, Mn: 0.05-1.00%, Al: 0.10-1.20%, and Cu: 0.05-2.00%.

Preferably, the present invention provides a non-oriented electrical steel plate, wherein the non-oriented electrical steel plate comprises the following chemical elements in wt %:
0<C≤0.0035%, Si: 2.00-3.80%, Mn: 0.05-1.00%, Al: 0.10-1.20%, Cu: 0.05-2.00%, and the balance of Fe and inevitable impurities.

In the non-oriented electrical steel plate in the present invention, the design principles of the chemical elements are as follows:

C: when the content of C is more than 0.0035%, it is easy to combine with harmful elements in steel to generate a large number of harmful inclusions, which pin the grain growth during continuous annealing and stress-relief annealing processes, thereby abnormally increasing in the iron loss of the finished steel plate. Based on this, the mass percentage of C is 0<C≤0.0035%, for example, 0.0014%≤C≤0.0029%.

Si: Si affects both the electromagnetic properties and mechanical properties of the finished steel plate. In the present invention, when the content of Si is more than 3.80%, it significantly deteriorates the magnetic induction of the finished steel plate and reduces its cold rolling workability; when the content of Si is less than 2.00%, it fails to effectively reduce core loss and improve mechanical strength. Based on this, the mass percentage of Si is 2.00%-3.80%. For example, the lower limit of the content of Si can be 2.08%, and the upper limit can be 3.78%, 3.45%.

Mn: Mn combines with the impurity element S to form MnS, which is beneficial to control the morphology and quantity of the inclusions, thereby effectively reducing their adverse effects on magnetic properties. Therefore, it is necessary to add 0.05% or more Mn in the present invention. If the content of Mn is more than 1.00%, it is easy to destroy the recrystallization beneficial texture of the finished steel plate and can greatly increase the manufacturing costs of the steel. Based on this, the mass percentage of Mn is 0.05%-1.00%. For example, the lower limit of the content of Mn can be 0.19%, 0.25%, and the upper limit can be 0.83%.

Al: Al can significantly increase the electrical resistivity of the material, improving the iron loss performance of the finished steel plate. In the present invention, when the content of Al is less than 0.10%, it fails to effectively reduce iron loss; when the content of Al is more than 1.20%, the castability of continuous casting molten steel will be significantly deteriorated. Based on this, the mass percentage of Al is 0.10%-1.20%. For example, the lower limit of Al content can be 0.40%, and the upper limit can be 1.16%.

Cu: In the present invention, the rational design of Cu content is very important. For non-oriented electrical steel with high Si+Al content, harmful inclusions are fine and numerous sulfur-based inclusions, which strongly inhibit grain growth during continuous annealing, especially during stress-relief annealing, thereby directly leading to serious deterioration of iron loss of the finished steel plate. Moreover, under the same S content, the thinner the finished steel plate, the greater its adverse effect on iron loss. To better control sulfide inclusions, the present invention adds 0.05% or more Cu to the steel to form spherical CuₓS inclusions that grow readily, thereby reducing their harm. However, when the content of Cu is more than 2.00%, it deteriorates the recrystallization effect during hot rolling, and the content of beneficial texture can be reduced, thereby significantly deteriorating the magnetic induction of the steel plate. Based on this, the mass percentage of Cu is 0.05%-2.00%. To further improve the beneficial effects of the steel plate, the mass percentage of Cu is preferably controlled at 0.10%-1.20%.

Preferably, the non-oriented electrical steel plate of the present invention further comprises at least one of Sn and Sb in a total amount of 0.005-0.200% by wt %. Sn and Sb are elements that enrich on the surface and segregate on grain boundaries, which can inhibit surface nitriding and oxidation of the finished steel plate during heat treatment. Therefore, preferably, the present invention allows the addition of 0.005% or more of Sn and Sb in total. However, when the total content of the Sn and Sb is more than 0.200%, it will cause severe grain refinement in the finished product, deteriorating the electromagnetic properties of the finished steel plate. More preferably, the mass percentage of Sn+Sb is 0.010-0.150%.

The respective content of Sn and Sb is not particularly limited, as long as the total amount of Sn+Sb satisfies the above-mentioned limitations. For example, the content of Sn can be 0-0.100% (e.g., 0.002-0.009%), and the content of Sb can be 0-0.130% (e.g., 0.003-0.100%).

Preferably, the non-oriented electrical steel plate of the present invention further comprises at least one of Ca, Mg, and REM in a total amount of 0.0003-0.0035% by wt %. Ca, Mg, and REM have strong deoxidation and desulfurization capabilities, which can form large particle inclusions that promote their floating and removal, and they can also inhibit the precipitation of fine sulfides, which is very beneficial for improving the cleanliness of steel. Therefore, preferably, the present invention allows the addition of 0.0003% or more of at least one of Ca, Mg, and REM. However, when the total content of Ca, Mg, and REM is more than 0.0035%, it will greatly increase the production cost of steel, and it is also not conducive to the stability of continuous casting. More preferably, the mass percentage of Ca+Mg+REM is 0.0005-0.0025%.

The respective content of each of Ca, Mg, and REM is not particularly limited, as long as the total amount of Ca+Mg+REM satisfies the above-mentioned limitations. For example, the content of Ca can be 0-0.0021% (e.g., 0.0007-0.0021%), the content of Mg can be 0-0.0010% (e.g., 0.0003-0.0010%), and the content of REM can be 0-0.0014% (e.g., 0.0007-0.0014%).

Preferably, the inevitable impurities comprise P, S, and N, and their contents satisfy at least one of the following: P≤0.20%, S≤0.0030%, N≤0.0020%.

The main impurity elements in the present invention are S, P, and N, and their contents should be controlled as low as possible. Among them:

In the invention, when the content of P is more than 0.20%, the cold rolling workability of high-silicon and high-aluminum silicon steel will be greatly reduced, causing abnormalities such as edge cracking or even strip breakage. Preferably, P≤0.19% (e.g., 0.01-0.19%).

When the content of S is more than 0.0030%, it is easy to cause a significant increase in the number of inclusions such as MnS and Cu₂S in the steel, which strongly inhibits grain growth during continuous annealing process, especially during the stress-relief annealing process, and deteriorates the electromagnetic properties of the finished steel plate. Preferably, S≤0.0028% (e.g., 0.0007-0.0028%).

When the content of N is more than 0.0020%, the inclusions will increase significantly, which will strongly inhibit the grain growth in the finished steel plate and deteriorate the electromagnetic properties of the finished steel plate. For example, 0.0010%≤N≤0.0020%.

Preferably, the mass percentage of Cu element further satisfies: 0.10-1.20%.

Preferably, the thickness of the non-oriented electrical steel plate of the present invention is ≤0.30 mm.

More preferably, the thickness of the non-oriented electrical steel plate of the present invention is ≤0.27 mm.

Preferably, the non-oriented electrical steel plate of the present invention (for example, the steel for white plate obtained after continuous annealing and leveling) has a yield strength of ≥500 MPa and a tensile strength of ≥600 MPa.

Preferably, the non-oriented electrical steel plate of the present invention (for example, the steel for black plate obtained after stress-relief annealing, if necessary) has an iron loss of P_{10/400}≤12.0 W/kg and a magnetic induction of B₅₀≥1.62 T.

Another objective of the present invention is to provide a method for manufacturing non-oriented electrical steel plates, which, with specific compositional design, optimizes the heating rate of the casting slab in the hot rolling heating furnace, and uses appropriate leveling reduction for steel plate thickness reduction, so that the steel for white plate obtained after continuous annealing and appropriate leveling has high strength, and the steel for black plate obtained after stress-relief annealing has low iron loss.

To achieve the above-mentioned objective, the present invention provides a method for manufacturing non-oriented electrical steel plates, which comprises the following steps:
(1) smelting and casting to obtain a casting slab;
(2) hot rolling, including heating, rough rolling, finish rolling, and coiling, wherein, in the heating step, the heating rate of the casting slab in 940-1030° C. range is 4.5-8.4° C./min;
(3) normalizing annealing;
(4) cold rolling;
(5) continuous annealing; and
(6) leveling and applying an insulating coating to obtain a white steel plate, wherein the leveling reduction rate is 0.5-8.0%, preferably 1.0-5.0%.

Preferably or optionally, the method further comprises:
(7) stress-relief annealing of the white steel plate obtained in step (6) to obtain a black steel plate.

Exemplarily, in step (1), smelting and casting can comprise: blast furnace molten iron→molten iron pretreatment→converter smelting→RH refining→continuous casting.

Exemplarily, in step (2), hot rolling can comprise: reheating of continuous casting slab→rough rolling→finish rolling→coiling.

Exemplarily, in step (3), normalizing annealing can comprise: hot coil preheating→soaking→cooling→shot blasting.

Exemplarily, in step (4), cold rolling can comprise: normalizing coil pickling→cold rolling→coiling.

Exemplarily, in step (5), continuous annealing can comprise: cold coil pre-cleaning→continuous annealing→post-cleaning.

For example, the production process can adopt a single cold rolling+continuous annealing or further adopt primary cold rolling+intermediate annealing+secondary cold rolling+continuous annealing, to obtain better electromagnetic properties of the finished steel plate.

In step (6), a white steel plate is obtained after leveling and applying an insulating coating.

In step (7), a black steel plate is obtained after stress-relief annealing (if necessary, for example, to further reduce the iron loss).

In step (2) of the method of the present invention, in the heating step, the heating rate of the casting slab (e.g., continuous casting slab) in the 940-1030° C. range is controlled to 4.5-8.4° C./min. The reason is that: in this temperature range, a large amount of CuₓS will dissolve, and then in the rolling process, as the temperature decreases, secondary precipitation will occur, the number of inclusions will increase sharply, and the particle size will decrease significantly, causing greater harm. At this time, adopting a rapid heating rate of 4.5-8.4° C./min can effectively avoid the detrimental effects of a low heating rate below 4.5° C./min, such as excessive dissolution of CuₓS and unfavorable texture formation. Conversely, when the heating rate exceeds 8.4° C./min, it will lead to a large difference in temperature gradient along the thickness direction of the casting slab, which is not conducive to the formation of coarse and well-developed recrystallized microstructures.

Another key process of the present invention is the appropriate leveling reduction rate. Wherein, the leveling reduction rate is 0.5-8.0%, and further preferably 1.0-5.0%. When the leveling reduction rate is less than 0.5%, it has little effect on improving the strength of the steel plate. When the leveling reduction rate is more than 8.0%, it causes a sharp increase in stored energy of the steel plate, severely deteriorates the favorable texture of the steel plate, resulting in a significant reduction in the iron loss and magnetic induction improvement effect of the steel plate after stress-relief annealing, failing to meet the performance requirements of iron loss P_{10/400}≤12.0 W/kg and magnetic induction B₅₀≥1.62 T.

In some embodiments of the present invention, the thickness of the steel plate after hot rolling is 1.2-3.0 mm, preferably 1.2-2.0 mm. The normalized steel coil can be rolled into the target steel plate thickness in a single rolling step in the subsequent cold rolling process.

Preferably, in the heating step of step (2), the heating time of the casting slab in a furnace is 120-360 minutes, and the discharge temperature is 1050-1150° C.

Preferably, in step (2), the rough rolling start temperature is 1030-1130° C.; and/or, the finish rolling end temperature is 650-950° C.; and/or, the coiling temperature is 500-850° C.

Preferably, the thickness of the steel plate obtained in step (2) is 1.2-3.0 mm, preferably 1.2-2.0 mm.

Preferably, in step (3), the soaking temperature for normalizing annealing is 820-980° C., and the soaking time is 1-10 minutes.

In the composition design of the present invention, soaking temperature of the hot-rolled steel coil during normalizing annealing can be appropriately increased to 820-980° C., and the normalizing annealing soaking time can be extended to 1-10 minutes, to achieve a coarser and more developed grain structures, which helps improve the magnetic induction of the steel plate and reduce its iron loss.

Preferably, in step (4), a single cold rolling is adopted, or a two-stage cold rolling with intermediate annealing is adopted, wherein the soaking temperature for the intermediate annealing is 720-950° C. and the soaking time is 10-60 seconds.

Preferably, in step (5), the soaking temperature for the continuous annealing is 720-950° C., and the soaking time is 10-60 seconds.

Exemplarily, the continuous annealing atmosphere is a hydrogen and nitrogen mixed gas (dry atmosphere), wherein the hydrogen content is 10-45% by volume.

Preferably, the iron loss P_{10/400} of the white steel plate obtained in step (6) is ≤19.2 W/kg; more preferably, the white steel plate has a yield strength of ≥500 MPa, a tensile strength of ≥600 MPa, and a magnetic induction of B₅₀≥1.62 T.

Preferably, the iron loss P_{10/400} of the black steel plate obtained in step (7) is ≤12.0 W/kg; more preferably, the black steel plate has a yield strength of ≥500 MPa, a tensile strength of ≥600 MPa, and a magnetic induction of B₅₀≥1.62 T.

The non-oriented electrical steel plate of the present invention has the beneficial effects of both high strength and excellent magnetic properties. Specifically, the white steel plate obtained after continuous annealing and leveling has a yield strength of ≥500 MPa, a tensile strength of ≥600 MPa (preferably, a magnetic induction of B₅₀≥1.62 T and an iron loss of P_{10/400}≤19.2 W/kg). The black steel plate obtained after stress-relief annealing has an iron loss of P_{10/400}≤12.0 W/kg, and a magnetic induction of B₅₀≥1.62 T (preferably, a yield strength of ≥500 MPa and a tensile strength of ≥600 MPa).

### BRIEF DESCRIPTION OF THE DRAWINGS

FIG. 1 shows the relationship between the wt % of element Cu in the non-oriented electrical steel plate of the present invention and the iron loss P_{10/400} after stress-relief annealing.

FIG. 2 shows the relationship between the leveling reduction rate and the yield strength of the non-oriented electrical steel plate of the present invention.

FIG. 3 shows the relationship between the leveling reduction rate and the tensile strength of the non-oriented electrical steel plate of the present invention.

### DETAILED DESCRIPTION

The non-oriented electrical steel plate and manufacturing method therefor in the present invention will be further explained and described below in conjunction with specific embodiments and the accompanying figures. However, the explanations and descriptions do not constitute improper limitations on the technical solutions of the present invention.

As mentioned above, the inventors have found through research that, under the compositional system of the present invention, the mass percentage of element Cu in the non-oriented electrical steel plate is closely related to the iron loss P_{10/400} of the steel plate after stress-relief annealing.

FIG. 1 shows the relationship between the mass percentage of element Cu in the non-oriented electrical steel plate of the present invention and the iron loss P_{10/400} after stress-relief annealing. As shown in FIG. 1, when mass percentage of element Cu is 0.5%, the iron loss P_{10/400} decreases to 12.0 W/kg, and when the mass percentage of element Cu is 1.6-1.8%, the iron loss P_{10/400} reaches the lowest value. However, when the content of element Cu is more than 2.00%, the iron loss P_{10/400} increases above 12.0 W/kg again. Therefore, the mass percentage of element Cu is set to 0.05-2.00% in the present invention.

In addition, the inventors have also found through research that, for the non-oriented electrical steel plate with the compositional ratios of the present invention, the leveling reduction rate is closely related to its yield strength and tensile strength.

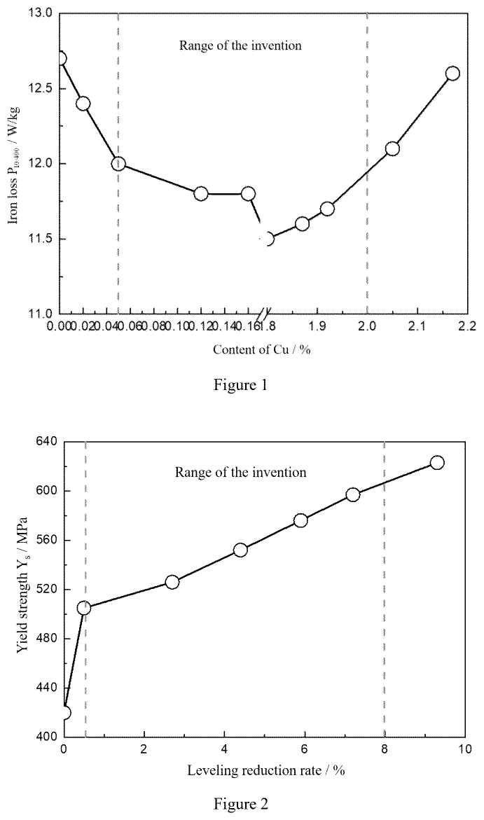

FIG. 2 shows the relationship between the leveling reduction rate and the yield strength of the non-oriented electrical steel plate of the present invention.

As shown in FIG. 2, when the leveling reduction rate of the steel plate is 0.5%, the yield strength of the steel plate reaches 500 MPa. Subsequently, as the leveling reduction rate increases, the yield strength of the steel plate continues to increase.

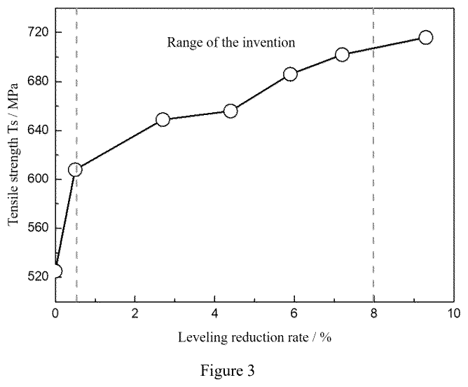

FIG. 3 shows the relationship between the leveling reduction rate and the tensile strength of the non-oriented electrical steel plate of the present invention.

As shown in FIG. 3, when the leveling reduction rate of the steel plate is 0.5%, the tensile strength of the steel plate reaches 600 MPa or more. Subsequently, as the leveling reduction rate increases, the tensile strength of the steel plate continues to increase.

### Examples 1-6 and Comparative Examples 1-2

Table 1-1 and 1-2 list the chemical compositions (in wt %) of the non-oriented electrical steel plates of Examples 1-6 and Comparative Examples 1-2, wherein the balance is Fe and inevitable impurities other than S, P, and N.

TABLE 1-1

| No. | C | Si | Mn | Al | Cu | P | S | N |
|---|---|---|---|---|---|---|---|---|
| Example 1 | 0.0025 | 2.47 | 0.83 | 1.20 | 1.20 | 0.02 | 0.0008 | 0.0016 |
| Example 2 | 0.0014 | 2.08 | 0.25 | 0.40 | 2.00 | 0.19 | 0.0028 | 0.0013 |
| Example 3 | 0.0035 | 2.52 | 1.00 | 1.16 | 0.06 | 0.03 | 0.0019 | 0.0013 |
| Example 4 | 0.0027 | 3.45 | 0.19 | 0.81 | 0.10 | 0.01 | 0.0007 | 0.0010 |
| Example 5 | 0.0018 | 2.92 | 0.05 | 0.64 | 1.05 | 0.10 | 0.0008 | 0.0020 |
| Example 6 | 0.0029 | 3.78 | 0.39 | 0.10 | 0.37 | 0.02 | 0.0013 | 0.0013 |
| Comparative | 0.0033 | 3.42 | 0.30 | 0.75 | 0.22 | 0.06 | 0.0018 | 0.0012 |
| Example1 | | | | | | | | |
| Comparative | 0.0011 | 3.91 | 0.19 | 0.28 | 0.01 | 0.10 | 0.0005 | 0.0017 |
| Example 2 | | | | | | | | |

TABLE 1-2

| No. | Sn | Sb | Ca | Mg | REM | Sn + Sb | Ca + Mg + REM |
|---|---|---|---|---|---|---|---|
| Example 1 | 0 | 0 | 0 | 0 | 0 | 0 | 0 |
| Example 2 | 0.002 | 0.003 | 0.0011 | 0.0010 | 0.0014 | 0.005 | 0.0035 |
| Example 3 | 0.010 | 0.010 | 0.0021 | 0 | 0 | 0.020 | 0.0021 |
| Example 4 | 0.009 | 0 | 0 | 0.0003 | 0 | 0.009 | 0.0003 |
| Example 5 | 0 | 0.130 | 0 | 0 | 0.0013 | 0.130 | 0.0013 |
| Example 6 | 0.100 | 0.100 | 0.0007 | 0.0004 | 0.0007 | 0.200 | 0.0018 |
| Comparative | 0 | 0.080 | 0.0005 | 0.0003 | 0.0018 | 0.080 | 0.0026 |
| Example1 | | | | | | | |
| Comparative | 0.150 | 0 | 0.0009 | 0.0005 | 0 | 0.150 | 0.0014 |
| Example 2 | | | | | | | |

The non-oriented electrical steel plates of Examples 1-6 and Comparative Examples 1-2 were prepared by the following steps (see Table 2 for specific process parameters). The critical difference is that the process parameters for Comparative Examples 1-2 do not meet one or more of the following parameters:

(1) smelting and casting to produce casting slab: the molten iron from the blast furnace underwent “three removals” in the pretreatment process and was then mixed with an appropriate proportion of scrap steel before being charged into the furnace. It then underwent smelting in the top and bottom combined blowing converter, RH refining, and continuous casting, resulting in casting slab with a thickness of 170-250 mm and a width of 800-1400 mm.

(2) hot rolling, including heating, rough rolling, finish rolling, and coiling: in the heating step, the heating time of the casting slab in the furnace was 120-360 minutes, with a discharge temperature of 1050-1150° C., and the heating rate of the casting slab in the temperature range of 940-1030° C. was 4.5-8.4° C./min; the rough rolling start temperature was 1030-1130° C., the finish rolling end temperature was 650-950° C., and the coiling temperature was 500-850° C.

(3) normalizing annealing: the soaking temperature for normalizing annealing was 820-980° C., and the soaking time was 1-10 minutes.

(4) cold rolling and continuous annealing: for Examples 1, 2, 4, and 5 as well as Comparative Example 1, single cold rolling to the final product thickness was performed, followed by continuous annealing; for Examples 3, 6, and Comparative Example 2, a process of primary cold rolling+intermediate annealing+secondary cold rolling+continuous annealing was adopted; wherein the continuous annealing soaking temperature was 720-950° C., the soaking time was 10-60 seconds, and the continuous annealing atmosphere was a mixture of hydrogen and nitrogen (dry atmosphere), with the hydrogen content being 10-45% by volume. In the case of intermediate annealing, the process parameters for the intermediate annealing were the same as those for continuous annealing.

(5) leveling and applying an insulating coating to obtain a white steel plate, wherein the leveling reduction rate was 0.5-8.0%.

(6) stress-relief annealing to obtain the black steel plate.

Table 2-1 and 2-2 list the specific process parameters of the manufacturing method of the non-oriented electrical steel plates of Examples 1-6 and Comparative Examples 1-2.

TABLE 2-1

| | Thickness | | | Heating | Start | End | | Thickness |
|---|---|---|---|---|---|---|---|---|
| | of final | Heating rate | Discharge | time in | temperature | temperature | Coiling | of hot |
| | product | (940-1030° C.) | temperature | furnace | of rough | of finish | temperature | rolled plate |
| Number | (mm) | (° C./min) | (° C.) | (min) | rolling (° C.) | rolling (° C.) | (° C.) | (mm) |
| Example 1 | 0.30 | 8.4 | 1147 | 155 | 1085 | 850 | 760 | 2.0 |
| Example 2 | 0.25 | 4.7 | 1150 | 200 | 1040 | 950 | 850 | 1.2 |
| Example 3 | 0.27 | 7.2 | 1137 | 120 | 1120 | 900 | 620 | 1.6 |
| Example 4 | 0.25 | 4.5 | 1109 | 180 | 1100 | 830 | 650 | 1.6 |
| Example 5 | 0.23 | 8.1 | 1125 | 240 | 1090 | 920 | 720 | 1.8 |
| Example 6 | 0.30 | 6.2 | 1050 | 360 | 1050 | 650 | 500 | 2.0 |
| Comparative | 0.25 | 3.2 | 1067 | 210 | 1120 | 850 | 800 | 1.6 |
| Example1 | | | | | | | | |
| Comparative | 0.27 | 4.9 | 1125 | 150 | 1080 | 900 | 570 | 2.6 |
| Example 2 | | | | | | | | |

TABLE 2-2

| | Normalizing | | Continuous | Leveling |
|---|---|---|---|---|
| | annealing | Intermediate | annealing | reduction |
| Number | (° C. × min) | annealing | (° C. × s) | rate (%) |
| Example 1 | 980 × 8 | x | 720 × 60 | 6.0 |
| Example 2 | 980 × 1 | x | 900 × 60 | 8.0 |
| Example 3 | 900 × 10 | ✓ | 900 × 25 | 4.0 |
| Example 4 | 880 × 2 | x | 850 × 40 | 0.5 |
| Example 5 | 820 × 5 | x | 950 × 10 | 2.0 |
| Example 6 | 850 × 2 | ✓ | 720 × 20 | 6.0 |
| Comparative | 900 × 2 | x | 950 × 20 | 0.0 |
| Example 1 | | x | | |
| Comparative | 850 × 3 | ✓ | 850 × 40 | 2.0 |
| Example 2 | | | | |

The inventors sampled the non-oriented electrical steel plates of Examples 1-6 and Comparatives Examples 1-2, observed the samples, and tested their relevant properties. The relevant performance results are listed in Table 3, and the relevant testing methods are as follows:

Iron loss: tested based on the national standard GB/T 3658-1990, using the Epstein frame method. The testing temperature was 20° C. (constant temperature), the sample size was 30 mm×300 mm, the target mass was 0.5 kg, and the testing parameter was P_{10/400}.

Magnetic induction: tested based on the national standard GB/T 3658-1990, using the Epstein frame method. The testing temperature was 20° C. (constant temperature), the sample size was 30 mm×300 mm, the target mass was 0.5 kg, and the testing parameter was B₅₀.

Mechanical properties: tested based on the national standard GB/T 228.1-2010, Metallic materials—Tensile testing—Part 1: Method of test at room temperature. Standard test samples were used after machining. The testing temperature was room temperature, and the gauge length of the test samples was 50 mm.

TABLE 3

| | | | | White steel | | |
|---|---|---|---|---|---|---|
| | White steel | White steel plate | White steel | magnetic | Black steel | Black steel |
| | plate yield | tensile strength | plate iron | induction | plate iron loss | plate magnetic |
| | strength Ys | Ts | loss P_{10/400} | plate B₅₀ | P_{10/400} | induction B₅₀ |
| Number | (MPa) | (MPa) | (W/kg) | (T) | (W/kg) | (T) |
| Example 1 | 525 | 631 | 18.1 | 1.68 | 11.4 | 1.65 |
| Example 2 | 514 | 613 | 19.2 | 1.70 | 11.8 | 1.68 |
| Example 3 | 571 | 654 | 17.1 | 1.68 | 10.9 | 1.67 |
| Example 4 | 537 | 627 | 16.3 | 1.69 | 10.6 | 1.67 |
| Example 5 | 546 | 675 | 15.8 | 1.66 | 11.2 | 1.66 |
| Example 6 | 582 | 694 | 14.2 | 1.66 | 11.3 | 1.64 |
| Comparative | 483 | 551 | 15.2 | 1.62 | 12.3 | 1.60 |
| Example1 | | | | | | |
| Comparative | 518 | 603 | 17.2 | 1.59 | 14.4 | 1.61 |
| Example 2 | | | | | | |

It can be seen that, in Examples 1-6 that meet the design requirements of the present invention, due to the adoption of corresponding chemical composition design, control requirements for the heating rate of the casting slab, and leveling reduction rate, all white steel plates after continuous annealing and leveling exhibit yield strength of more than 500 MPa, tensile strength of more than 600 MPa, iron loss P_{10/400} of less than 20.0 W/kg, and magnetic induction B₅₀ of more than 1.62 T. Furthermore, after stress-relief annealing, all black steel plates achieve further reduced iron losses P_{10/400} below 12.0 W/kg, while maintaining magnetic induction B₅₀ above 1.62 T, yield strength above 500 MPa, and tensile strength above 600 MPa.

In Comparative Example 1, the method did not comply with the design requirements of the present invention, and the heating rate of the casting slab was only 3.2° C./min, which is below the lower limit of 4.5° C./min specified by the present invention, and leveling was not performed after continuous annealing. Therefore, the yield strength of the white steel plate in Comparative Example 1 is 483 MPa and the tensile strength is 551 MPa, both of which are lower than the lower limits of 500 MPa and 600 MPa, respectively, specified by the present invention. Moreover, the iron loss of the black steel plate in Comparative Example 1 is 12.3 W/kg (higher than the upper limit of 12.0 W/kg specified by the present application), and the magnetic induction is 1.60 T (lower than the lower limit of 1.62 T specified by the present application).

In Comparative Example 2, the method does not comply with the design requirements of the present invention. The content of Cu was only 0.01%, which is lower than the lower limit of 0.05% of the design requirements of the present invention. In addition, the content of Si was as high as 3.91%, exceeding the upper limit of 3.8% of the design requirements of the present invention. Therefore, after continuous annealing and leveling, the yield strength of the white steel plate is 518 MPa and the tensile strength is 603 MPa, which meet the lower limits of 500 MPa and 600 MPa of the design requirements of the present invention. However, after stress relief annealing, the iron loss P_{10/400} of the black steel plate is 14.4 W/kg and the magnetic induction B₅₀ is 1.61 T, which does not meet the requirements of iron loss P_{10/400}≤12.0W/kg and magnetic induction B₅₀≥1.62T specified by the present invention.

It should be noted that the combination of technical features in the present invention are not limited to the combinations described in the claims the specific embodiments of the present invention. All technical features described in this document can be freely combined or integrated in any manner unless contradicted by each other.

It should be further noted that the embodiments listed above are merely specific implementations of the present invention. Obviously, the present invention is not limited to the these embodiments. Similar variations or modifications that can be directly derived or easily associated by those skilled in the art from the disclosure of the present invention shall fall within the protection scope of the present invention.

1. A non-oriented electrical steel plate, wherein in addition to Fe and inevitable impurities, the non-oriented electrical steel plate further comprises the following chemical elements in wt %:
0<C≤0.0035%, Si: 2.00-3.80%, Mn: 0.05-1.00%, Al: 0.10-1.20%, and Cu: 0.05-2.00%.

2. The non-oriented electrical steel plate according to claim 1, wherein the non-oriented electrical steel plate consists of the following chemical elements in wt %:
0<C≤0.0035%, Si: 2.00-3.80%, Mn: 0.05-1.00%, Al: 0.10-1.20%, Cu: 0.05-2.00%, and the balance of Fe and inevitable impurities.

3. The non-oriented electrical steel plate according to claim 1, wherein the non-oriented electrical steel plate further comprises, in wt %, at least one of Sn and Sb in a total amount of 0.005-0.200%, and/or at least one of Ca, Mg, and REM in a total amount of 0.0003-0.0035%.

4. The non-oriented electrical steel plate according to claim 1, wherein the inevitable impurities comprises at least one of P, S, and N, and their contents satisfy at least one of the following: P≤0.20%, S≤0.0030%, N≤0.0020%.

5. The non-oriented electrical steel plate according to claim 1, wherein the content of element Cu is 0.10-1.20%.

6. The non-oriented electrical steel plate according to claim 1, wherein the thickness of the non-oriented electrical steel plate is ≤0.30 mm.

7. The non-oriented electrical steel plate according to claim 1, wherein the non-oriented electrical steel plate has a yield strength of ≥500 MPa, and a tensile strength of ≥600 MPa.

8. The non-oriented electrical steel plate according to claim 1, wherein the non-oriented electrical steel plate has an iron loss P_{10/400} of ≤12.0 W/kg, and a magnetic induction B₅₀ of ≥1.62 T.

9. A method for manufacturing the non-oriented electrical steel plate according to claim 1, wherein the method comprises the following steps:
(1) smelting and casting to obtain a casting slab;
(2) hot rolling, including heating, rough rolling, finish rolling, and coiling; wherein, in the heating step, a heating rate of the casting slab in a temperature range of 940-1030° C. is 4.5-8.4° C./min;
(3) normalizing annealing;
(4) cold rolling;
(5) continuous annealing; and
(6) leveling and applying an insulating coating to obtain a white steel plate, wherein a leveling reduction rate is 0.5-8.0%, preferably 1.0-5.0%.

10. The method according to claim 9, wherein the method further comprises:
(7) the white steel plate obtained in step (6) is subjected to stress-relief annealing to obtain a black steel plate.

11. The method according to claim 9, wherein step (2) satisfies one or more of the following:
in the heating step, a furnace heating time for the casting slab is 120-360 minutes, and a discharge temperature is 1050-1150° C.;
a rough rolling start temperature is 1030-1130° C.;
a finish rolling end temperature is 650-950° C.;
a coiling temperature is 500-850° C.; and
a thickness of the steel plate obtained in step (2) is 1.2-3.0 mm, preferably 1.2-2.0 mm.

12. The method according to claim 9, wherein in step (3), a soaking temperature for normalizing annealing is 820-980° C., and a soaking time is 1-10 minutes.

13. The method according to claim 9, wherein in step (4), a single cold rolling is adopted, or a two-stage cold rolling with intermediate annealing is adopted, wherein a soaking temperature of the intermediate annealing is 720-950° C. and a soaking time is 10-60 seconds.

14. The method according to claim 9, wherein in step (5), a soaking temperature for continuous annealing is 720-950° C., and a soaking time is 10-60 seconds; and/or, a continuous annealing atmosphere is a hydrogen+nitrogen mixed gas, wherein a hydrogen content is 10-45% by volume.

15. The method according to claim 9, wherein an iron loss P_{10/400} of the white steel plate obtained in step (6) is ≤19.2 W/kg; preferably, the white steel plate has a yield strength of ≥500 MPa, a tensile strength of ≥600 MPa, and a magnetic induction of B₅₀≥1.62 T.

16. The method according to claim 10, wherein an iron loss P_{10/400} of the black steel plate obtained in step (7) is ≤12.0 W/kg; preferably, the black steel plate has a yield strength of ≥500 MPa, a tensile strength of ≥600 MPa, and a magnetic induction of B₅₀≥1.62 T.

17. The non-oriented electrical steel plate according to claim 2, wherein the content of element Cu is 0.10-1.20%.

18. The non-oriented electrical steel plate according to claim 2, wherein the thickness of the non-oriented electrical steel plate is ≤0.30 mm.

19. The non-oriented electrical steel plate according to claim 2, wherein the non-oriented electrical steel plate has a yield strength of ≥500 MPa, and a tensile strength of ≥600 MPa.
